(19) United States
(12) Patent Application Publication
(10) Pub. No.: US 2017/0323006 A1
(43) Pub. Date: Nov. 9, 2017

(54) SYSTEM AND METHOD FOR PROVIDING ANALYTICS IN REAL-TIME BASED ON UNSTRUCTURED ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/596,492

(22) Filed: May 16, 2017

Related U.S. Application Data
(63) Continuation-in-part of application No. 15/361,934, filed on Nov. 28, 2016.
(60) Provisional application No. 62/337,885, filed on May 18, 2016.
(60) Provisional application No. 62/260,553, filed on Nov. 29, 2015.
(60) Provisional application No. 62/261,355, filed on Dec. 1, 2015.

(51) Int. Cl. G06F 17/30; G06K 9/00; G06F 17/24; G06Q 40/00

(52) U.S. Cl. CPC G06F 17/30616; G06K 9/00442; G06F 17/248; G06F 17/30011; G06Q 40/10

(57) ABSTRACT

A system and method for generating analytics based on unstructured electronic documents. The method includes analyzing a plurality of electronic documents to determine at least one transaction parameter for each electronic document, wherein at least one of the analyzed electronic documents includes at least partially unstructured data; creating a template for each analyzed electronic document, wherein each template is a structured dataset including the determined at least one transaction parameter for the respective electronic document; obtaining, based on the created templates, at least one transaction analysis rule set, wherein each transaction analysis rule set at least defines requirements for obtaining a transaction reclaim; and generating at least one analytic based on the at least one transaction analysis rule set, the created templates, and at least one enterprise parameter.

### CROSS-REFERENCE TO RELATED APPLICATIONS

This application claims the benefit of U.S. Provisional Application No. 62/337,885 filed on May 18, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to providing reclaim analytics, and more particularly to providing reclaim analytics based on electronic documents.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

Upon receiving such assurances, a purchase order may be generated for the customer. The purchase order provides evidence of the order such as, for example, a purchase price, goods and/or services ordered, and the like. Later, an invoice for the order may be generated. While the purchase order is usually used to indicate which products are requested and an estimate or offering for the price, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases in which the total price of the invoice is different from the total price of the purchase order are difficult to track, especially in large enterprises accepting many orders daily (e.g., in a large hotel chain managing hundreds or thousands of hotels in a given country). The differences may cause errors in recordkeeping for enterprises.

As businesses increasingly rely on technology to manage data related to operations such as invoice and purchase order data, suitable systems for properly managing and collecting data have become crucial to success. Particularly for large businesses, the amount of data utilized daily by businesses can be overwhelming. Accordingly, manual review and collection of such data is impractical, at best.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use. As a result, enterprises typically hire accounting firms to manually review scanned receipts and other unstructured electronic documents. However, such firms are typically cost prohibitive, and are still subject to human error.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for generating analytics based on at least partially unstructured electronic documents. The method comprises: analyzing a plurality of electronic documents to determine at least one transaction parameter for each electronic document, wherein at least one of the analyzed electronic documents includes at least partially unstructured data; creating a template for each analyzed electronic document, wherein each template is a structured dataset including the determined at least one transaction parameter for the respective electronic document; obtaining, based on the created templates, at least one transaction analysis rule set, wherein each transaction analysis rule set at least defines requirements for obtaining a transaction reclaim; and generating at least one analytic based on the at least one transaction analysis rule set, the created templates, and at least one enterprise parameter.

Certain embodiments disclosed herein also include a non-transitory computer readable medium having stored thereon instructions for causing a processing circuitry to perform a process, the process comprising: analyzing a plurality of electronic documents to determine at least one transaction parameter for each electronic document, wherein at least one of the analyzed electronic documents includes at least partially unstructured data; creating a template for each analyzed electronic document, wherein each template is a structured dataset including the determined at least one transaction parameter for the respective electronic document; obtaining, based on the created templates, at least one transaction analysis rule set, wherein each transaction analysis rule set at least defines requirements for obtaining a transaction reclaim; and generating at least one analytic based on the at least one transaction analysis rule set, the created templates, and at least one enterprise parameter.

Certain embodiments disclosed herein also include a system for generating analytics based on at least partially unstructured electronic documents. The system comprises: a processing circuitry; and a memory, the memory containing instructions that, when executed by the processing circuitry, configure the system to: analyze a plurality of electronic documents to determine at least one transaction parameter for each electronic document, wherein at least one of the analyzed electronic documents includes at least partially unstructured data; create a template for each analyzed electronic document, wherein each template is a structured dataset including the determined at least one transaction parameter for the respective electronic document; obtain based on the created templates, at least one transaction analysis rule set, wherein each transaction analysis rule set at least defines requirements for obtaining a transaction reclaim; and generate at least one analytic based on the at least one transaction analysis rule set, the created templates, and at least one enterprise parameter.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a document analyzer according to an embodiment.

FIG. 3 is a flowchart illustrating a method for generating analytics based on at least partially unstructured electronic documents according to an embodiment.

FIG. 4 is a flowchart illustrating a method for creating a dataset based on at least one electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating analytics based on electronic documents. In an embodiment, at least one dataset is created based on electronic documents indicating transaction information related to an enterprise. A template of transaction attributes is created based on each electronic document dataset. The templates are structured datasets created based on at least partially unstructured data generated via machine imaging of the electronic documents.

Based on the created templates, a country of each transaction indicated by one of the templates is determined. At least one transaction analysis rule set is obtained based on the determined countries. Based on the created templates and at least one enterprise parameter, analytics are generated using the at least one transaction analysis rule set. The enterprise parameters may be obtained with respect to an enterprise identified based on the transaction parameters in the created templates. Based on the analytics, a notification indicating a potential for a VAT reclaim may be provided.

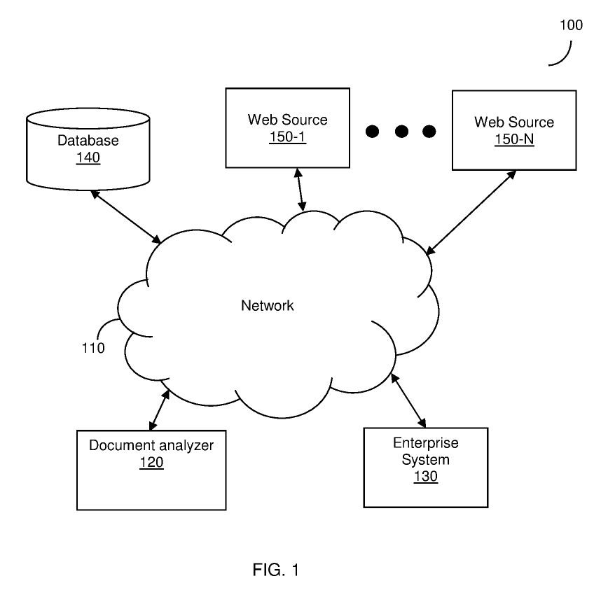

FIG. 1 shows an example network diagram 100 utilized to describe the various disclosed embodiments. In the example network diagram 100, a document analyzer 120, an enterprise system 130, a database 140, and a plurality of web sources 150-1 through 150-N (hereinafter referred to individually as a web source 150 and collectively as web sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to transactions involving the enterprise or representatives of the enterprise as well as data related to the enterprise itself. The enterprise may be, but is not limited to, an enterprise such as a business whose employees may purchase goods and services pursuant to their roles and responsibilities. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing, for example, a scan of an invoice, a text file, a spreadsheet file, etc.), enterprise parameters, or both. Each electronic document may show, e.g., an invoice, a tax receipt, a purchase number record, and the like. Data included in at least some of the electronic documents is at least partially unstructured such that the data may be structured, semi-structured, unstructured, or a combination thereof. The structured or semi-structured data may be in a format that is not recognized by the document analyzer 120 and, therefore, may be treated as unstructured data.

The enterprise parameters may include, but are not limited to, a country of establishment (e.g., a country of incorporation), an indication of whether the enterprise is privately owned or publicly traded, whether there are subsidiaries of the enterprise, whether the enterprise is owned by another enterprise, a combination thereof, and the like.

Each electronic document may be related to a transaction involving the enterprise. Consequently, the electronic documents may indicate at least expenses incurred by the enterprise during the transaction and other information related thereto. As a non-limiting example, an electronic document may indicate a type of good or service purchased (e.g., a hotel stay), a time of the transaction, a price per unit, a quantity, a buyer, a supplier (e.g., a seller or a manufacturer), supplier information (e.g., name, merchant registration number, etc.), combinations thereof, and the like.

The database 140 stores at least analytics associated with a plurality of enterprises generated by the document analyzer 120. The database 140 may also store notifications generated by the document analyzer 120.

At least some of the web sources 150 store at least rules related to value-added tax (VAT) reclaims. The web sources 150 may include, but are not limited to, tax authority servers, accounting servers, and the like.

In an embodiment, the document analyzer 120 is configured to create templates based on transaction parameters identified using machine vision on at least partially unstructured electronic documents indicating information related to transactions. In a further embodiment, the document analyzer 120 may be configured to retrieve the electronic documents from, e.g., the enterprise system 130. Alternatively or collectively, electronic documents may be received from client devices (not shown) utilized by employees or other representatives of the enterprise. Based on the created templates, the document analyzer 120 is generate analytics for the enterprise, and may further generate notifications indicating potential for VAT reclaim for transactions indicated in the electronic documents.

Each template is a structured dataset including the identified transaction parameters for a transaction. The transaction parameters indicate information related to the transaction that are indicated in the electronic document such as, but not limited to, a type of good or service purchased (e.g., a hotel stay), a time of the transaction, a price per unit, a quantity, a buyer, a supplier (e.g., a seller or a manufacturer), supplier information (e.g., name, merchant registration number, etc.), and the like.

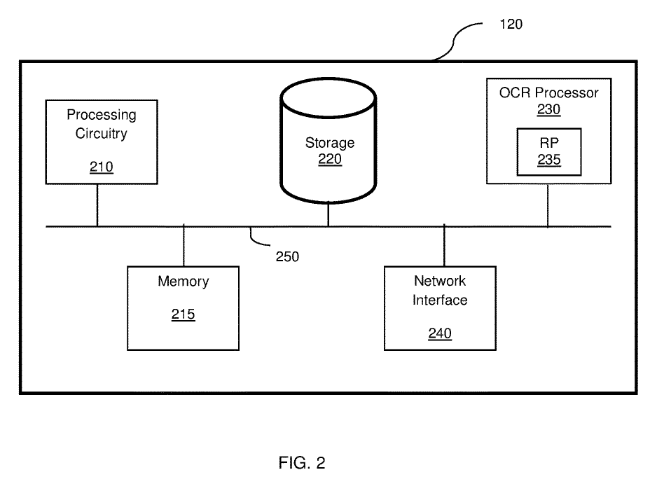

In an embodiment, the document analyzer 120 is configured to create datasets based on at least partially unstructured electronic documents including data at least partially lacking a known structure (e.g., unstructured data, semi-structured data, or structured data having an unknown structure). To this end, in a further embodiment, the document analyzer 120 may be further configured to utilize optical character recognition (OCR) or other image processing to determine data in the electronic document. The document analyzer 120 may therefore include or be communicatively connected to a recognition processor (e.g., the recognition processor 235, FIG. 2). Based on the datasets, the document analyzer 120 is configured to create the templates.

In another embodiment, the document analyzer 120 may be further configured to validate each electronic document based on its respective template. The validation may include, but is not limited to, determining whether each electronic document is complete and accurate.

Each electronic document may be determined to be complete if, for example, one or more predetermined reporting requirements is met (e.g., for a purchase, relevant requirements may include types of goods or services purchased, total price, quantity, supplier, etc.).

Each electronic document may be determined to be accurate based on data stored in at least one external source. The at least one external source may include, but is not limited to, one or more web sources or other data sources (not shown). As a non-limiting example, a merchant server of a merchant who was the seller in a transaction may be queried for metadata related to the electronic document associated with the transaction, and the metadata obtained via the query may be compared to data of the template for the electronic document. For example, the metadata obtained via the query may include a price of the transaction, a transaction identifier, and the like, which may be compared to data in corresponding fields of the template created for the transaction.

In an embodiment, the document analyzer 120 is configured to obtain enterprise parameters related to an enterprise indicated by the transaction parameters of the created templates. The enterprise parameters may be obtained from the enterprise system 130, a data source (e.g., one of the web sources 150), and the like. In a further embodiment, the enterprise parameters may be obtained with respect to an enterprise that is common to all of the templates. As a non-limiting example, if each of the created templates include a “buyer” field containing the same enterprise name (i.e., if the buyer for each transaction is the same), the enterprise parameters may be retrieved from a data source associated with the buyer enterprise.

In an embodiment, based on the created templates, the document analyzer 120 is configured to determine at least one country in which a transaction involving an enterprise occurred. In a further embodiment, each country may be indicated in a “location (country)” field of one of the created templates.

In an embodiment, for each determined country, the document analyzer 120 is configured to obtain a transaction analysis rule set. Each transaction analysis rule set may be, for example, a VAT reclaim rule set utilized for determining whether a transaction is eligible for VAT reclaim, a likelihood of success based on the electronic documents and the transaction parameters, or both. In a further embodiment, the document analyzer 120 may be configured to retrieve each transaction analysis rule set from one of the web sources 150. In yet a further embodiment, each transaction analysis rule set is obtained from one of the web sources 150 that is associated with one of the determined countries. As a non-limiting example, the web sources 150 may include tax authority servers related to a plurality of countries, and transaction analysis rules sets may be obtained from tax authority servers of locations of transactions indicated in the templates.

In an embodiment, the document analyzer 120 is configured to generate at least one analytic based on the templates and the enterprise parameters. In a further embodiment, the document analyzer 120 is configured to utilize one of the transaction analysis rule sets to the transaction parameters of each template and the enterprise parameters. Each applied transaction analysis rule set is applied to transaction parameters of a template indicating the country of the transaction analysis rule set.

In an embodiment, the analytics indicate information related to a potential VAT reclaim for the transactions or for each transaction and may indicate, but are not limited to, a potential amount of VAT reclaim that can be obtained with respect to each transaction, a total amount of potential VAT reclaims for at least one group of the transactions, a likelihood of success of obtaining a VAT reclaim using each analyzed electronic document, and the like. In a further embodiment, the analytics may be, for example, stored in a database (e.g., the database 140), sent to the enterprise system 130, sent for display on a user device (not shown), a combination thereof, and the like.

In another embodiment, generating the analytics may further include comparing the enterprise parameters and the transaction parameters of each template to a plurality of predetermined sets of enterprise parameters and transaction parameters associated with known VAT reclaim success results. In a further embodiment, based on the comparison, a likelihood of success for reclaiming each transaction may be determined.

As a non-limiting example, the document analyzer 120 retrieves scanned invoices from an enterprise system of an enterprise seeking information related to potential VAT reclaims. The scanned invoices are analyzed, and structured dataset templates are created based on the analysis. Enterprise parameters indicating that the enterprise is a pharmaceutical company and that the enterprise was established in Germany are received from the enterprise system 130. A country of each transaction is determined based on transaction parameters in a “location” field of each template. The document analyzer 120 retrieves VAT reclaim rules from a tax authority server associated with each determined country. Based on the VAT reclaim rules, the enterprise parameters, and the created templates, analytics indicating that VAT reclaims can be obtained for at least some of the transactions indicated in the electronic documents, and that $50,000 USD may be reclaimed for the transactions.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the document analyzer 120 according to an embodiment. The document analyzer 120 includes a processing circuitry 210 coupled to a memory 215, a storage 220, and a network interface 240. In an embodiment, the document analyzer 120 may include an optical character recognition (OCR) processor 230. In another embodiment, the components of the document analyzer 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to generate analytics based on at least partially unstructured electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in at least partially unstructured data sets. Specifically, in an embodiment, the OCR processor 230 is configured to identify at least characters in the unstructured data. The identified characters may be utilized to create a dataset including data required for analyzing transactions and generating recommendations based thereon.

The network interface 240 allows the document analyzer 120 to communicate with the enterprise system 130, the database 140, or both, for purposes such as, for example, obtaining electronic documents, storing transaction historical records, obtaining transaction historical records, sending recommendations, and the like.

It should be understood that the embodiments described herein are not limited to the specific architecture illustrated in FIG. 2, and other architectures may be equally used without departing from the scope of the disclosed embodiments.

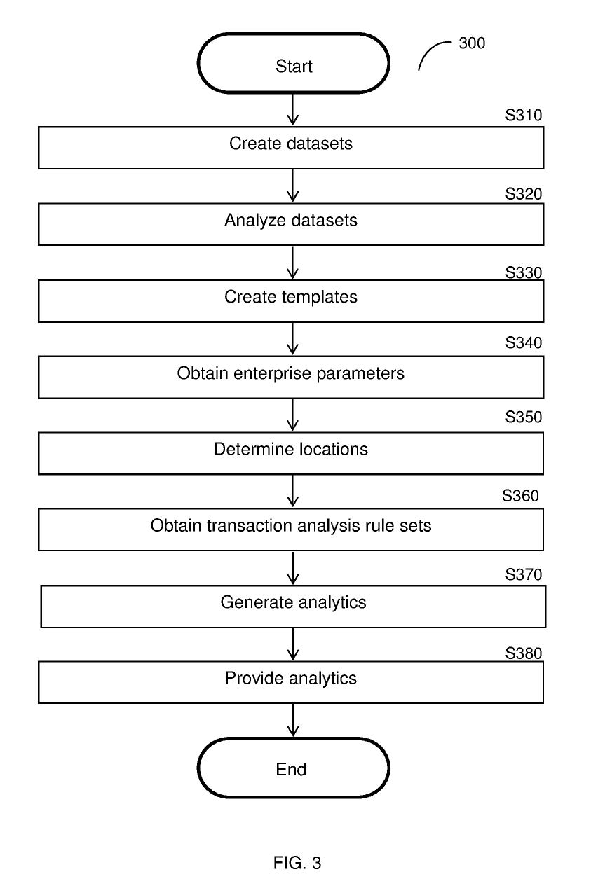

FIG. 3 is an example flowchart 300 illustrating a method for generating analytics based on electronic documents according to an embodiment. In an embodiment, the method is performed by the document analyzer 120. In another embodiment, the analytics may be VAT reclaim analytics for transactions indicated in the electronic documents.

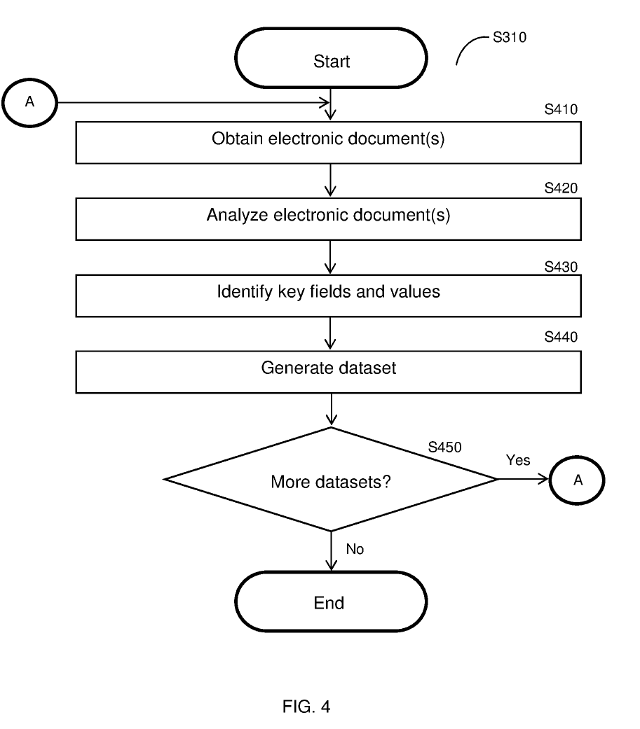

At S310, a dataset is created for each electronic document including information related to a transaction. Each electronic document indicates at least partially unstructured data of a transaction involving the enterprise and may include, but is not limited to, unstructured data, semi-structured data, structured data with structure that is unanticipated or unannounced, or a combination thereof. In an embodiment, S310 may further include analyzing each electronic document using optical character recognition (OCR) to determine data in the electronic document, identifying key fields in the data, identifying values in the data, or a combination thereof. Creating datasets based on at least partially unstructured electronic documents is described further herein below with respect to FIG. 4.

At S320, the datasets are analyzed. In an embodiment, analyzing each dataset may include, but is not limited to, determining transaction parameters such as, but not limited to, at least one enterprise identifier (e.g., a consumer enterprise identifier, a merchant enterprise identifier, or both), information related to the transaction (e.g., a date, a time, a price, a type of good or service sold, etc.), or both. In a further embodiment, analyzing each dataset may also include identifying the transaction based on the dataset.

At S330, a template is created based on each analyzed dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S340, at least one enterprise parameter is obtained. In an embodiment, the at least one enterprise parameter is retrieved from an enterprise system associated with an entity. In another embodiment, S340 may include identifying the enterprise based on the templates and retrieving the at least one enterprise parameter based on the identified enterprise. The identified enterprise may be an enterprise that is common among all of the templates.

At S350, based on the created templates, at least one location is determined. Each determined location is indicated in at least one of the created templates. In an embodiment, S350 may include identifying a transaction parameter in a “location” field of each template, where the identified transaction parameter indicates the location of a transaction.

At S360, based on the determined at least one location, at least one transaction analysis rule set is obtained. Each transaction analysis rule set may be obtained from a data source (e.g., one of the web sources 150, FIG. 1) associated with one of the determined locations. For example, each determined location may be a country, and each transaction analysis rule set may be a VAT reclaim requirements rule set retrieved from a tax authority server corresponding to one of the countries.

At S370, based on the at least one enterprise parameter and the created templates, analytics are generated. In a further embodiment, the document analyzer 120 is configured to utilize one of the transaction analysis rule sets to the transaction parameters of each template and the enterprise parameters. Each applied transaction analysis rule set is applied to transaction parameters of a template indicating the country of the transaction analysis rule set.

In an embodiment, the analytics indicate information related to a potential VAT reclaim for the transactions or for each transaction and may indicate, but are not limited to, a potential amount of VAT reclaim that can be obtained with respect to each transaction, a total amount of potential VAT reclaims for at least one group of the transactions, a likelihood of success of obtaining a VAT reclaim using each analyzed electronic document, and the like.

In an embodiment, generating at least some of the analytics may include comparing the at least one enterprise parameter and the transaction parameters of each template to a plurality of sets of enterprise parameters and transaction parameters associated with known VAT reclaim results. The comparison may be utilized to, e.g., determine a likelihood of success of reclaiming a VAT for each transaction based on the at least one enterprise parameter and the transaction parameters of the transaction, for example, based on a proportion of successful VAT reclaims having enterprise and transaction parameters matching the determined enterprise and transaction parameters above a predetermined threshold. As a non-limiting example, for a travel agency established in Italy, the comparison may be to parameters of other travel agencies established in the European Union.

At S380, the generated analytics may be provided. In an embodiment, providing the analytics may include, but is not limited to, storing the analytics in a database, sending the analytics to an enterprise system, sending the analytics for display to a user device, or a combination thereof.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

At S450, it is determined if structured datasets for additional transactions are to be created and, if so, execution continues with S410; otherwise, execution terminates.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating analytics based on at least partially unstructured electronic documents, comprising:
analyzing a plurality of electronic documents to determine at least one transaction parameter for each electronic document, wherein at least one of the analyzed electronic documents includes at least partially unstructured data;
creating a template for each analyzed electronic document, wherein each template is a structured dataset including the determined at least one transaction parameter for the respective electronic document;
obtaining, based on the created templates, at least one transaction analysis rule set, wherein each transaction analysis rule set at least defines requirements for obtaining a transaction reclaim; and
generating at least one analytic based on the at least one transaction analysis rule set, the created templates, and at least one enterprise parameter.

2. The method of claim 1, wherein determining the at least one transaction parameter for each electronic document further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

4. The method of claim 1, wherein obtaining the at least one transaction analysis rule set further comprises:
determining, based on the created templates, at least one location; and
retrieving, from a data source associated with each determined location, one of the at least one transaction analysis rule set.

5. The method of claim 4, each template including a location field, wherein determining the at least one location further comprises:
identifying, in each template, a transaction parameter indicating a location in the location field of the template, wherein the determined at least one location includes each distinct identified location transaction parameter.

6. The method of claim 1, further comprising at least one of: sending the generated at least one analytic to an enterprise system, sending the generated at least one analytic to a client device, and storing the generated at least one analytic in a storage.

7. The method of claim 1, further comprising:
identifying an enterprise indicated in the created templates; and
obtaining, based on the identified enterprise, the at least one enterprise parameter.

8. The method of claim 1, wherein the at least one analytic indicates at least a potential for value-added tax reclaim of each transaction.

9. The method of claim 1, wherein generating the at least one analytic further comprises:
comparing the transaction parameters of each template to a plurality of predetermined sets of transaction parameters, wherein the analytics are generated based on the comparison.

10. A non-transitory computer readable medium having stored thereon instructions for causing a processing circuitry to perform a process, the process comprising:
analyzing a plurality of electronic documents to determine at least one transaction parameter for each electronic document, wherein at least one of the analyzed electronic documents includes at least partially unstructured data;
creating a template for each analyzed electronic document, wherein each template is a structured dataset including the determined at least one transaction parameter for the respective electronic document;
obtaining, based on the created templates, at least one transaction analysis rule set, wherein each transaction analysis rule set at least defines requirements for obtaining a transaction reclaim; and
generating at least one analytic based on the at least one transaction analysis rule set, the created templates, and at least one enterprise parameter.

11. A system for validating generating analytics based on at least partially unstructured electronic documents, comprising:
a processing circuitry; and
a memory, the memory containing instructions that, when executed by the processing circuitry, configure the system to:
analyze a plurality of electronic documents to determine at least one transaction parameter for each electronic document, wherein at least one of the analyzed electronic documents includes at least partially unstructured data;
create a template for each analyzed electronic document, wherein each template is a structured dataset including the determined at least one transaction parameter for the respective electronic document;
obtain, based on the created templates, at least one transaction analysis rule set, wherein each transaction analysis rule set at least defines requirements for obtaining a transaction reclaim; and
generate at least one analytic based on the at least one transaction analysis rule set, the created templates, and at least one enterprise parameter.

12. The system of claim 11, wherein the system is further configured to:
identify, in the electronic document, at least one key field and at least one value;
create, based on the electronic document, a dataset, wherein the created dataset includes the at least one key field and the at least one value; and
analyze the created dataset, wherein the at least one transaction parameter is determined based on the analysis.

13. The system of claim 12, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

14. The system of claim 11, wherein the system is further configured to:
determine, based on the created templates, at least one location; and
retrieve, from a data source associated with each determined location, one of the at least one transaction analysis rule set.

15. The system of claim 14, each template including a location field, wherein the system is further configured to:
identify, in each template, a transaction parameter indicating a location in the location field of the template, wherein the determined at least one location includes each distinct identified location transaction parameter.

16. The system of claim 11, wherein the system is further configured to perform at least one of: send the generated at least one analytic to an enterprise system, send the generated at least one analytic to a client device, and store the generated at least one analytic in a storage.

17. The system of claim 11, wherein the system is further configured to:
identify an enterprise indicated in the created templates; and
obtain, based on the identified enterprise, the at least one enterprise parameter.

18. The system of claim 11, wherein the at least one analytic indicates at least a potential for value-added tax reclaim of each transaction.

19. The system of claim 11, wherein the system is further configured to:
compare the transaction parameters of each template to a plurality of predetermined sets of transaction parameters, wherein the analytics are generated based on the comparison.

20. The system of claim 11, further comprising:
an optical character recognition processor, wherein the system is further configured to:
analyze, by the optical character recognition, the plurality of electronic documents to identify data in the electronic documents, wherein the at least one transaction parameter of each electronic document is determined based on the identified data of the electronic document.
